(19) United States
(12) Patent Application Publication
(10) Pub. No.: US 2025/0216519 A1
(43) Pub. Date: Jul. 3, 2025

(54) HIGH-RANGE, LOW-POWER LIDAR SYSTEMS, AND RELATED METHODS AND APPARATUS

(71) Applicant: VELODYNE LIDAR USA, INC., San Jose, CA (US)

(72) Inventor: Mathew Noel Rekow, Ben Lomond, CA (US)

(21) Appl. No.: 17/710,904

(22) Filed: Mar. 31, 2022

Related U.S. Application Data
(60) Provisional application No. 63/169,174, filed on Mar. 31, 2021.

(51) Int. Cl. G01S 7/487; G01S 7/481; G01S 7/4865; G01S 17/10

(52) U.S. Cl. CPC G01S 7/487; G01S 7/4816; G01S 7/4817; G01S 7/4865; G01S 17/10

(57) ABSTRACT

A LIDAR system may include a transmitter, a photodetector, and a receiver. The receiver may transmit an optical signal having a signature. The photodetector may detect a return signal and generate a captured signal representing the return signal. The receiver may process the captured signal to determine a propagation time of the optical signal between the transmitter and the surface. The receiver may include signal processing components and timing circuitry. The signal processing components may digitize the captured signal and determine whether a signature of the digitized signal matches the signature of the optical signal. The timing circuitry may determine the propagation time of the optical signal between the transmitter and the surface based on the digitized signal when the signature of the digitized signal is determined to match the signature of the optical signal.

### CROSS-REFERENCE TO RELATED APPLICATIONS

This application claims the priority and benefit under 35 U.S.C. § 119(e) of U.S. Provisional Patent Application No. 63/169,174, titled “High-Range, Low-Power LIDAR Systems, and Related Methods and Apparatus” and filed on Mar. 31, 2021, which is hereby incorporated by reference herein in its entirety.

### FIELD OF TECHNOLOGY

The present disclosure relates generally to high-range, low-power light detection and ranging (“LiDAR”) systems.

### BACKGROUND

Light detection and ranging (“LiDAR”) systems measure the attributes of their surrounding environments (e.g., shape of a target, contour of a target, distance to a target, etc.) by illuminating the target with light (e.g., laser light) and measuring the reflected light with sensors. Differences in laser return times and/or wavelengths can then be used to make digital, three-dimensional (“3D”) representations of a surrounding environment. LiDAR technology may be used in various applications including autonomous vehicles, advanced driver assistance systems, mapping, security, surveying, robotics, geology and soil science, agriculture, and unmanned aerial vehicles, airborne obstacle detection (e.g., obstacle detection systems for aircraft), etc. Depending on the application and associated field of view, multiple channels or laser beams may be used to produce images in a desired resolution. A LiDAR system with greater numbers of channels can generally generate larger numbers of pixels.

In a multi-channel LiDAR device, optical transmitters can be paired with optical receivers to form multiple “channels.” In operation, each channel's transmitter can emit an optical signal (e.g., laser) into the device's environment, and the channel's receiver can detect the portion of the signal that is reflected back to the channel by the surrounding environment. In this way, each channel can provide “point” measurements of the environment, which can be aggregated with the point measurements provided by the other channel(s) to form a “point cloud” of measurements of the environment.

The measurements collected by a LiDAR channel may be used to determine the distance (“range”) from the device to the surface in the environment that reflected the channel's transmitted optical signal back to the channel's receiver. In some cases, the range to a surface may be determined based on the time of flight of the channel's signal (e.g., the time elapsed from the transmitter's emission of the optical signal to the receiver's reception of the return signal reflected by the surface). In other cases, the range may be determined based on the wavelength (or frequency) of the return signal(s) reflected by the surface.

In some cases, LiDAR measurements may be used to determine the reflectance of the surface that reflects an optical signal. The reflectance of a surface may be determined based on the intensity on the return signal, which generally depends not only on the reflectance of the surface but also on the range to the surface, the emitted signal's glancing angle with respect to the surface, the power level of the channel's transmitter, the alignment of the channel's transmitter and receiver, and other factors.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### SUMMARY

According to an aspect of the present disclosure, a LIDAR system includes a transmitter configured to transmit an optical signal having a signature, a photodetector configured to detect a return signal and generate a captured signal representing the return signal, wherein the return signal includes a portion of the optical signal reflected by a surface in an environment of the LIDAR system; and a receiver configured to process the captured signal to determine a propagation time of the optical signal between the transmitter and the surface. The receiver includes signal processing components and timing circuitry, wherein the signal processing components are configured to digitize the captured signal and determine whether a signature of the digitized signal matches the signature of the optical signal, and the timing circuitry is configured to determine the propagation time of the optical signal between the transmitter and the surface based on the digitized signal when the signature of the digitized signal is determined to match the signature of the optical signal.

According to another aspect of the present disclosure, a method includes transmitting, with a transmitter of a LIDAR system, an optical signal having a signature; with a photodetector of the LIDAR system, detecting a return signal and generating a captured signal representing the return signal, wherein the return signal includes a portion of the optical signal reflected by a surface in an environment of the LIDAR system; and processing, with a receiver of the LIDAR system, the captured signal to determine a propagation time of the optical signal between the transmitter and the surface. The processing includes digitizing the captured signal, determining whether a signature of the digitized signal matches the signature of the optical signal, and determining the propagation time of the optical signal between the transmitter and the surface based on the digitized signal when the signature of the digitized signal is determined to match the signature of the optical signal.

These and other objects, along with advantages and features of embodiments of the present invention herein disclosed, will become more apparent through reference to the following description, the figures, and the claims. Furthermore, it is to be understood that the features of the various embodiments described herein are not mutually exclusive and can exist in various combinations and permutations.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 is an illustration of the operation of a LiDAR system, in accordance with some embodiments.

FIG. 2A is another illustration of the operation of a LiDAR system, in accordance with some embodiments.

FIG. 2B is an illustration of a LiDAR system with an oscillating mirror, in accordance with some embodiments.

FIG. 2C is an illustration of a three-dimensional (“3D”) LiDAR system, in accordance with some embodiments.

FIG. 3A illustrates another LiDAR system, according to some embodiments.

FIG. 3B illustrates a LiDAR receiver, according to some embodiments.

FIG. 4A is a scatter plot illustrating signal to noise ratio in signals captured and processed by a LiDAR receiver under various operating conditions, in accordance with some embodiments.

FIG. 4B illustrates mathematical equations representing signal to noise ratios in signals captured and processed by a LiDAR receiver under various operating conditions, in accordance with some embodiments.

FIG. 5 illustrates a technique for matching a signal captured by a LiDAR receiver to a signature of a transmitted signal, in accordance with some embodiments.

FIG. 6 is a line graph illustrating a relationship between a number of samples of peaks of a return signal (“real hits”) in a signal captured by a LiDAR receiver and a normalized peak value of a correlation waveform, in accordance with some embodiments.

FIG. 7A illustrates another example of a signal captured by a LiDAR receiver, in accordance with some embodiments.

FIG. 7B illustrates amplitude jitter observed at an output of an analog-to-digital converter (ADC), in accordance with some embodiments.

FIG. 7C illustrates peak-to-peak amplitude variation observed at an output of an ADC as a function of avalanche photodiode (APD) bias voltage, in accordance with some embodiments.

FIG. 7D illustrates another example of a signal captured by a LiDAR receiver, in accordance with some embodiments.

FIG. 8 illustrates additional examples of a signature of a transmitted signal and a corresponding signal captured by a LiDAR receiver, in accordance with some embodiments.

FIGS. 9A and 9B illustrate results of simulations performed using the signature of the transmitted signal and the captured signal of FIG. 8, in accordance with some embodiments.

FIG. 10 illustrates electro-optical conversion efficiency of a LiDAR transmitter as a function of the peak current through the laser diode, in accordance with some embodiments.

FIG. 11 illustrates a technique for a LiDAR channel to perform long-range detection and short-range detection within a single listening period, in accordance with some embodiments.

FIG. 12 is a block diagram of a computing device/information handling system, in accordance with some embodiments.

FIG. 13 shows a block diagram of a computing device/information handling system, in accordance with some embodiments.

While the present disclosure is subject to various modifications and alternative forms, specific embodiments thereof have been shown by way of example in the drawings and will herein be described in detail. The present disclosure should be understood to not be limited to the particular forms disclosed, but on the contrary, the intention is to cover all modifications, equivalents, and alternatives falling within the spirit and scope of the present disclosure.

### DETAILED DESCRIPTION

Apparatus and methods for high-range, low-power LiDAR are disclosed. It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details.

### Terms

As used herein, “return signal” may refer to an optical signal (e.g., laser beam) that is emitted by a LIDAR device, reflected by a surface in the environment of the LIDAR device, and detected by an optical detector of the LIDAR device.

As used herein, “captured signal” may refer to an electrical signal produced by a LIDAR receiver in response to detecting a return signal (e.g., a ‘captured analog signal’ produced by a photodetector, a ‘captured digital signal’ produced by an analog-to-digital converter, etc.).

As used herein, “processed signal” may refer to a signal produced by a digital signal processing device or a component thereof (e.g., a correlation filter).

As used herein, “real hits” may refer to digital samples of peaks in a captured analog signal corresponding to peaks in a return signal, and “spurious hits” may refer to digital samples of noise in a captured analog signal.

As used herein, “listening period” may refer to a time period in which a photodetector of a LIDAR receiver is activated (e.g., able to detect return signals).

As used herein, “electro-optical efficiency” may refer to electrical-to-optical power efficiency (e.g., the ratio of a system's optical output power to its consumed electrical input power.

As used herein, “signature,” “energy signature,” or “pulse signature” may refer to the shape of a waveform of an optical or electrical signal. For example, the signature of a signal may include one or more of the following characteristics of the signal's waveform: number of pulses, attributes of each pulse (e.g., amplitude, intensity, width, etc.) (which may be uniform or non-uniform), time delays between pairs of adjacent pulses (which may be uniform or non-uniform)periodicity of pulses (e.g., the rate at which individual pulses or sets of pulses repeat), etc.

### Motivation for and Benefits of Some Embodiments

LiDAR systems with greater range and/or improved electro-optical efficiency are needed. One option for increasing the range of a LiDAR system is to increase the peak power of the optical signals (e.g., pulsed laser beams) transmitted by the system, thereby increasing the signal-to-noise ratio (SNR) in signals captured by the LiDAR receiver when return signals are reflected by distant objects. However, simply increasing the peak power of the transmitted optical pulses tends to decrease the system's electro-optical efficiency.

A second option for increasing the range of LiDAR systems is to (1) select an operating point for the system detector that enhances (e.g., maximizes) the signal-to-noise ratio in signals captured by the receiver, and/or (2) use digital signal processing techniques to reliably detect energy signatures of return signals in the signals captured by the receiver even when the return signals are relatively weak. Using these techniques can improve both the range and the electro-optical efficiency of LiDAR systems.

### Some Examples of LiDAR Systems

A light detection and ranging (“LiDAR”) system may be used to measure the shape and contour of the environment surrounding the system. LiDAR systems may be applied to numerous applications including autonomous navigation and aerial mapping of surfaces. In general, a LiDAR system emits light that is subsequently reflected by objects within the environment in which the system operates. In some examples, the LiDAR system is configured to emit light pulses. The time each pulse travels from being emitted to being received (i.e., time-of-flight, “TOF” or “ToF”) may be measured to determine the distance between the LiDAR system and the object that reflects the pulse. In other examples, the LiDAR system can be configured to emit continuous wave (CW) light. The wavelength (or frequency) of the received, reflected light may be measured to determine the distance between the LiDAR system and the object that reflects the light. In some examples, LiDAR systems can measure the speed (or velocity) of objects. The science of LiDAR systems is based on the physics of light and optics.

In a LiDAR system, light may be emitted from a rapidly firing laser. Laser light travels through a medium and reflects off points of surfaces in the environment (e.g., surfaces of buildings, tree branches, vehicles, etc.). The reflected light energy returns to a LiDAR detector where it may be recorded and used to map the environment.

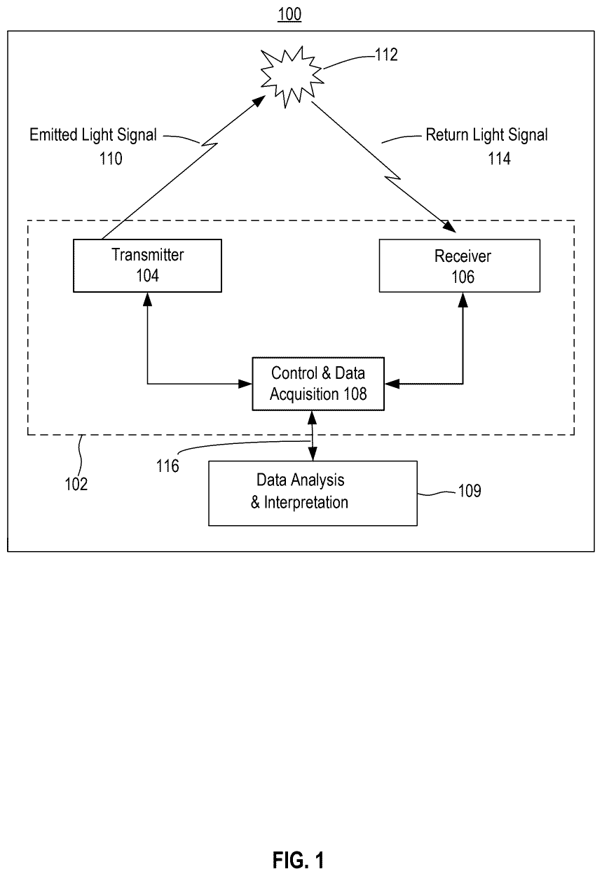

FIG. 1 depicts the operation of a LiDAR system 100, according to some embodiments. In the example of FIG. 1, the LiDAR system 100 includes a LiDAR device 102, which may include a transmitter 104 that generates and emits a light signal 110, a receiver 106 that detects a return light signal 114, and a control & data acquisition module 108. The transmitter 104 may include a light source (e.g., laser), electrical components operable to activate (“drive”) and deactivate the light source in response to electrical control signals, and optical components adapted to shape and redirect the light emitted by the light source. The receiver 106 may include an optical detector (e.g., photodiode) and optical components adapted to shape return light signals 114 and direct those signals to the detector. In some implementations, one or more of optical components (e.g., lenses, mirrors, etc.) may be shared by the transmitter and the receiver. The LiDAR device 102 may be referred to as a LiDAR transceiver or “channel.” In operation, the emitted (e.g., illumination) light signal 110 propagates through a medium and reflects off an object(s) 112, whereby a return light signal 114 propagates through the medium and is received by receiver 106.

The control & data acquisition module 108 may control the light emission by the transmitter 104 and may record data derived from the return light signal 114 detected by the receiver 106. In some embodiments, the control & data acquisition module 108 controls the power level at which the transmitter 104 operates when emitting light. For example, the transmitter 104 may be configured to operate at a plurality of different power levels, and the control & data acquisition module 108 may select the power level at which the transmitter 104 operates at any given time. Any suitable technique may be used to control the power level at which the transmitter 104 operates. In some embodiments, the control & data acquisition module 108 determines (e.g., measures) particular characteristics of the return light signal 114 detected by the receiver 106. For example, the control & data acquisition module 108 may measure the intensity of the return light signal 114 using any suitable technique.

A LiDAR transceiver 102 may include one or more optical lenses and/or mirrors (not shown) to redirect and shape the emitted light signal 110 and/or to redirect and shape the return light signal 114. The transmitter 104 may emit a laser beam (e.g., a beam having a plurality of pulses in a particular sequence). Design elements of the receiver 106 may include its horizontal field of view (hereinafter, “FOV”) and its vertical FOV. One skilled in the art will recognize that the FOV parameters effectively define the visibility region relating to the specific LiDAR transceiver 102. More generally, the horizontal and vertical FOVs of a LiDAR system 100 may be defined by a single LiDAR device (e.g., sensor) or may relate to a plurality of configurable sensors (which may be exclusively LiDAR sensors or may have different types of sensors). The FOV may be considered a scanning area for a LiDAR system 100. A scanning mirror and/or rotating assembly may be utilized to obtain a scanned FOV.

In some implementations, the LiDAR system 100 may include or be electronically coupled to a data analysis & interpretation module 109, which may receive outputs (e.g., via connection 116) from the control & data acquisition module 108 and perform data analysis functions on those outputs. The connection 116 may be implemented using a wireless or non-contact communication technique.

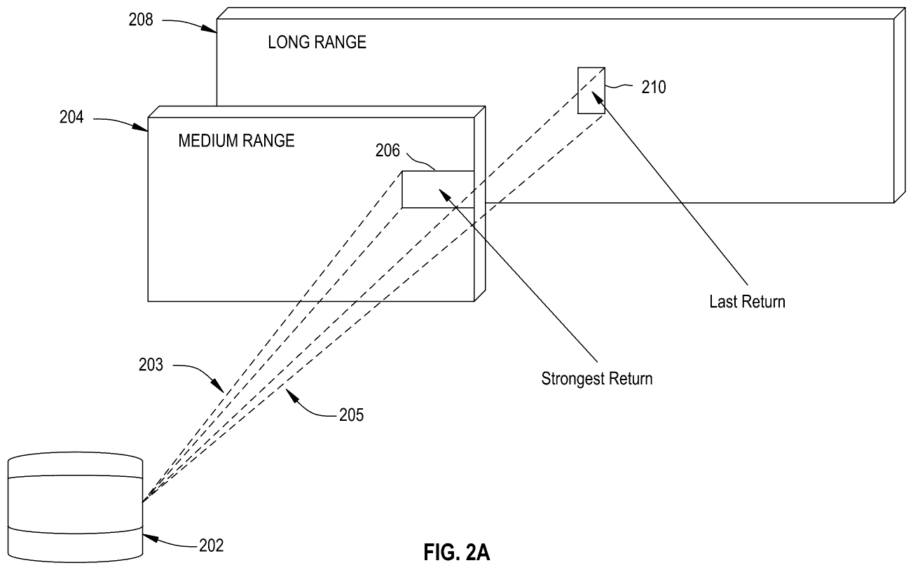

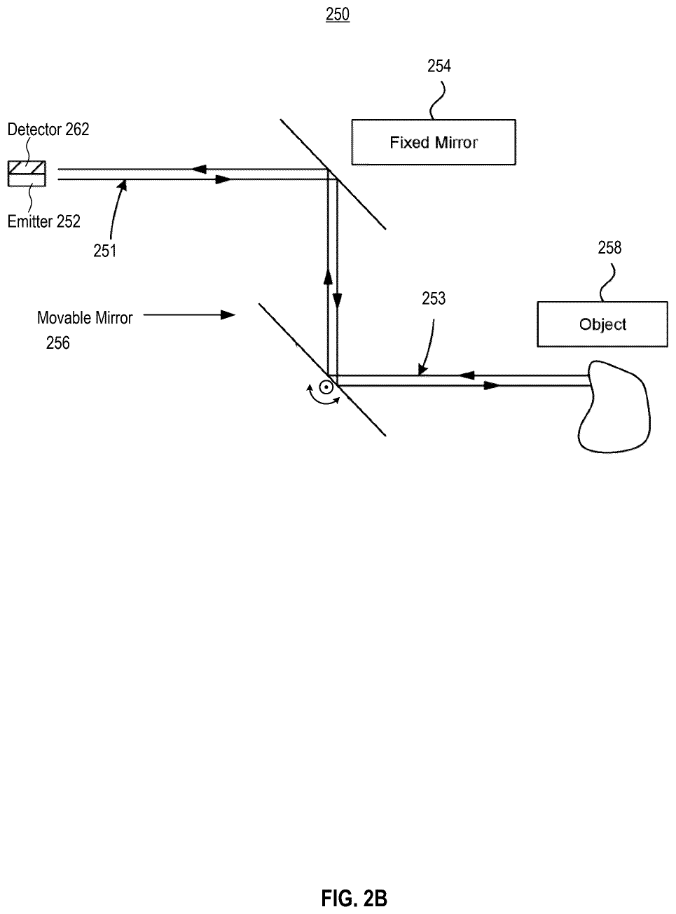

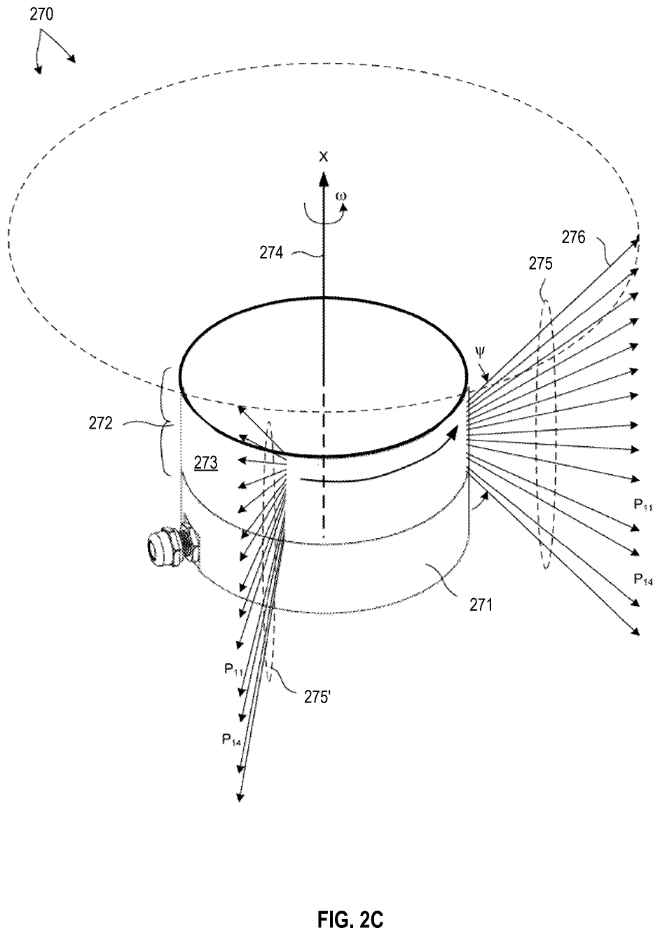

FIG. 2A illustrates the operation of a LiDAR system 202, in accordance with some embodiments. In the example of FIG. 2A, two return light signals 203 and 205 are shown. Laser beams generally tend to diverge as they travel through a medium. Due to the laser's beam divergence, a single laser emission may hit multiple objects at different ranges from the LiDAR system 202, producing multiple return signals 203, 205. The LiDAR system 202 may analyze multiple return signals 203, 205 and report one of the return signals (e.g., the strongest return signal, the last return signal, etc.) or more than one (e.g., all) of the return signals. In the example of FIG. 2A, LiDAR system 202 emits laser light in the direction of near wall 204 and far wall 208. As illustrated, the majority of the emitted light hits the near wall 204 at area 206 resulting in a return signal 203, and another portion of the emitted light hits the far wall 208 at area 210 resulting in a return signal 205. Return signal 203 may have a shorter TOF and a stronger received signal strength compared with return signal 205. In both single-and multiple-return LiDAR systems, it is important that each return signal is accurately associated with the transmitted light signal so that one or more attributes of the object that reflect the light signal (e.g., range, velocity, reflectance, etc.) can be correctly calculated.

Some embodiments of a LiDAR system may capture distance data in a two-dimensional (2D) (e.g., single plane) point cloud manner. These LiDAR systems may be used in industrial applications, or for surveying, mapping, autonomous navigation, and other uses. Some embodiments of these systems rely on the use of a single laser emitter/detector pair combined with a moving mirror to effect scanning across at least one plane. This mirror may reflect the emitted light from the transmitter (e.g., laser diode), and/or may reflect the return light to the receiver (e.g., to the detector). Use of a movable (e.g., oscillating) mirror in this manner may enable the LiDAR system to achieve 90-180-360 degrees of azimuth (horizontal) view while simplifying both the system design and manufacturability. Many applications require more data than just a 2D plane. The 2D point cloud may be expanded to form a three-dimensional (“3D”) point cloud, in which multiple 2D point clouds are used, each pointing at a different elevation (e.g., vertical) angle. Design elements of the receiver of the LiDAR system 202 may include the horizontal FOV and the vertical FOV.

FIG. 2B depicts a LiDAR system 250 with a movable (e.g., oscillating) mirror, according to some embodiments. In the example of FIG. 2B, the LiDAR system 250 uses a single emitter 252/detector 262 pair combined with a fixed mirror 254 and a movable mirror 256 to effectively scan across a plane. Distance measurements obtained by such a system may be effectively two-dimensional (e.g., planar), and the captured distance points may be rendered as a 2D (e.g., single plane) point cloud. In some embodiments, but without limitation, the movable mirror 256 may oscillate at very fast speeds (e.g., thousands of cycles per minute).

The emitted laser signal 251 may be directed to a fixed mirror 254, which may reflect the emitted laser signal 251 to the movable mirror 256. As movable mirror 256 moves (e.g., oscillates), the emitted laser signal 251 may reflect off an object 258 in its propagation path. The reflected return signal 253 may be coupled to the detector 262 via the movable mirror 256 and the fixed mirror 254. Design elements of the LiDAR system 250 include the horizontal FOV and the vertical FOV, which define a scanning area.

FIG. 2C depicts a 3D LiDAR system 270, according to some embodiments. In the example of FIG. 2C, the 3D LiDAR system 270 includes a lower housing 271 and an upper housing 272. The upper housing 272 includes a cylindrical shell element 273 constructed from a material that is transparent to infrared light (e.g., light having a wavelength within the spectral range of 700 to 1,700 nanometers). In one example, the cylindrical shell element 273 is transparent to light having wavelengths centered at 905 nanometers.

In some embodiments, the 3D LiDAR system 270 includes a LiDAR transceiver 102 operable to emit laser beams 276 through the cylindrical shell element 273 of the upper housing 272. In the example of FIG. 2C, each individual arrow in the sets of arrows 275, 275′ directed outward from the 3D LiDAR system 270 represents a laser beam 276 emitted by the 3D LiDAR system. Each beam of light emitted from the system 270 may diverge slightly, such that each beam of emitted light forms a cone of illumination light emitted from system 270. In one example, a beam of light emitted from the system 270 illuminates a spot size of 20 centimeters in diameter at a distance of 100 meters from the system 270.

In some embodiments, the transceiver 102 emits each laser beam 276 transmitted by the 3D LiDAR system 270. The direction of each emitted beam may be determined by the angular orientation ω of the transceiver's transmitter 104 with respect to the system's central axis 274 and by the angular orientation ψ of the transmitter's movable mirror 256 with respect to the mirror's axis of oscillation (or rotation). For example, the direction of an emitted beam in a horizontal dimension may be determined by the transmitter's angular orientation ω, and the direction of the emitted beam in a vertical dimension may be determined by the angular orientation ψ of the transmitter's movable mirror. Alternatively, the direction of an emitted beam in a vertical dimension may be determined the transmitter's angular orientation ω, and the direction of the emitted beam in a horizontal dimension may be determined by the angular orientation ψ of the transmitter's movable mirror. (For purposes of illustration, the beams of light 275 are illustrated in one angular orientation relative to a non-rotating coordinate frame of the 3D LiDAR system 270 and the beams of light 275′ are illustrated in another angular orientation relative to the non-rotating coordinate frame.)

The 3D LiDAR system 270 may scan a particular point (e.g., pixel) in its field of view by adjusting the orientation ω of the transmitter and the orientation ψ of the transmitter's movable mirror to the desired scan point (ω, ψ) and emitting a laser beam from the transmitter 104. Likewise, the 3D LiDAR system 270 may systematically scan its field of view by adjusting the orientation ω of the transmitter and the orientation ψ of the transmitter's movable mirror to a set of scan points (ωᵢ, ψⱼ) and emitting a laser beam from the transmitter 104 at each of the scan points.

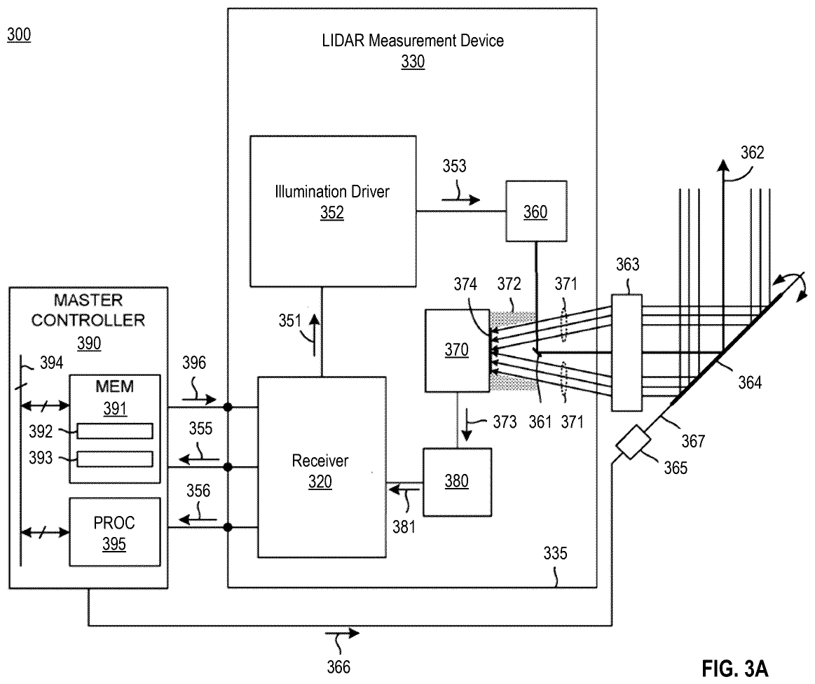

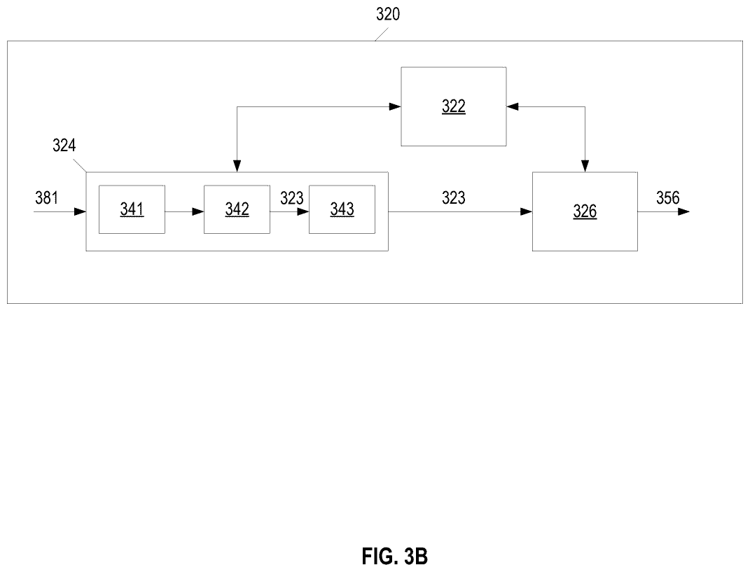

FIG. 3A depicts a LIDAR system 300 in one embodiment. LIDAR system 300 includes a master controller 390 and one or more LIDAR measurement devices 330 (e.g., integrated LIDAR measurement devices). A LIDAR measurement device 330 includes a receiver 320 (e.g., receiver integrated circuit (IC)), an illumination driver 352 (e.g., illumination driver integrated circuit (IC)), an illumination source 360, a photodetector 370, and an amplifier 380 (e.g., trans-impedance amplifier (TIA)). Each of these components can be mounted to a common substrate 335 (e.g., printed circuit board) that provides mechanical support and electrical connectivity among the components.

Illumination source 360 emits illumination light 362 in response to electrical signal (e.g., current) 353. In some embodiments, the illumination source 360 is laser based (e.g., laser diode). In some embodiments, the illumination source includes one or more light emitting diodes. In general, any suitable pulsed illumination source may be contemplated. In some embodiments, illumination source 360 is a multi-mode, wavelength-locked laser diode. Illumination light 362 exits LIDAR measurement device 300 and reflects from an object in the surrounding environment under measurement. A portion of the reflected light is collected as return measurement light 371 associated with the illumination light 362. As depicted in FIG. 3A, illumination light 362 emitted from LIDAR measurement device 330 and corresponding return measurement light 371 directed toward LIDAR measurement device 330 share a common optical path within at least a portion of LIDAR measurement device 330.

In one aspect, the illumination light 362 is focused and projected toward a particular location in the surrounding environment by one or more beam shaping optical elements 363 and a beam scanning device 364 of LIDAR system 300. In a further aspect, the return measurement light 171 is directed and focused onto photodetector 370 by beam scanning device 364 and the one or more beam shaping optical elements 363 of LIDAR system 300. The beam scanning device is disposed in the optical path between the beam shaping optics and the environment under measurement. The beam scanning device effectively expands the field of view and increases the sampling density within the field of view of the LIDAR system 300.

In the example depicted in FIG. 3A, beam scanning device 364 includes a moveable mirror that is rotated about an axis of rotation 367 by rotary actuator 365. However, any suitable beam scanning device 364 can be used. Command signals 366 generated by master controller 390 are communicated from master controller 390 to rotary actuator 365. In response, rotary actuator 365 scans the moveable mirror in accordance with a desired motion profile. In some embodiments, LIDAR system 300 scans the environment by rotating one or more LIDAR measurement devices 330 about an axis of rotation as described above with reference to FIG. 2C, rather than using an optical beam scanning device 364.

LIDAR measurement device 330 includes a photodetector 370 having an active sensor area 374. In some embodiments, illumination source 160 is located outside the field of view of the active area 374 of the photodetector. In some embodiments, an overmold lens 372 is mounted over the photodetector 370. The overmold lens 372 may have a conical cavity that corresponds with the ray acceptance cone of return light 371. Illumination light 162 from illumination source 360 can be injected into the detector reception cone by a fiber waveguide. An optical coupler optically couples illumination source 360 with the fiber waveguide. At the end of the fiber waveguide, a mirror component 361 can be oriented at a 45 degree angle with respect to the waveguide to inject the illumination light 362 into the cone of return light 371. In one embodiment, the end faces of fiber waveguide are cut at a 45 degree angle and the end faces are coated with a highly reflective dielectric coating to provide a mirror surface. In some embodiments, the waveguide includes a rectangular shaped glass core and a polymer cladding of lower index of refraction. In some embodiments, the entire optical assembly is encapsulated with a material having an index of refraction that closely matches the index of refraction of the polymer cladding. In this manner, the waveguide injects the illumination light 362 into the acceptance cone of return light 371 with minimal occlusion. The placement of the waveguide within the acceptance cone of the return light 371 projected onto the active sensing area 374 of detector 370 is selected to promote maximum overlap of the illumination spot and the detector field of view in the far field. Any suitable architecture for the optical assembly may be used.

As depicted in FIG. 3A, return light 371 reflected from the surrounding environment is detected by photodetector 370. In some embodiments, photodetector 370 is an avalanche photodiode (e.g., biased as described herein). Photodetector 370 generates an output signal 373 (e.g., “captured signal”) that is amplified by an amplifier 180 (e.g., an analog trans-impedance amplifier (TIA)). However, in general, the amplification of output signal 373 may include multiple, amplifier stages. In this sense, an analog trans-impedance amplifier is provided by way of non-limiting example, as many other analog signal amplification schemes may be contemplated within the scope of this patent document. Although amplifier 380 is depicted in FIG. 3A as a discrete device separate from the receiver 320, in general, amplifier 380 may be integrated with receiver 320. In some embodiments, it is preferable to integrate amplifier 380 with receiver 320 to save space and reduce signal contamination.

The amplified captured signal 381 is communicated to receiver 320. As can be seen in FIG. 3B, receiver 320 can include a controller 322, signal processing components 324, and timing circuitry 326. The controller 322 may control the operation of the receiver. For example, the controller 326 may control the receiver's communication with the illumination driver 352 and/or master controller 390, supply timing information to the timing circuitry 324 (e.g., a signal indicating the time at which the illumination source 360 emitted the illumination light 362), etc. The signal processing components 324 (described in further detail below) can digitize segments of the amplified captured signal 381 that include peak values and process the digitized captured signal to determine whether the characteristics of the light 371 detected by the photodetector 370 match the characteristics of the illumination light 362. If so, the detected light 371 is determined to be an actual return signal, and the timing circuitry 326 can estimate the time of flight of the illumination light from illumination source 360 to a reflective object in the 3-D environment and back to the photodetector 370. In some embodiments, the timing circuitry 326 includes a time-to-digital converter that generates that time-of-flight estimate.

In some embodiments, two or more of the signal processing components 322, timing circuitry 324, and controller 326 are integrated onto a single, silicon-based microelectronic chip (e.g., ASIC). In another embodiment these same components are integrated into a single gallium-nitride or silicon based chip (e.g., ASIC) that also includes the illumination driver. In some embodiments, the time-of-flight estimate 356 is generated by the receiver 320 and sent to the master controller 390 for further processing by the master controller 390 (or by one or more processors of LIDAR system 300 or external to LIDAR system 300) to determine a distance measurement based on the time-of-flight estimate. In some embodiments, the distance measurement 355 is determined by the receiver 320 and communicated to the master controller 390 (with or without the associated time-of-flight estimate).

In some embodiments, master controller 390 is configured to generate a pulse command signal 396 that is communicated to receiver 320 of LIDAR measurement device 330. Pulse command signal 396 can be a digital signal generated by master controller 390. Thus, the timing of pulse command signal 396 can be determined by a clock associated with master controller 390. In some embodiments, the pulse command signal 396 is directly used to trigger pulse generation by illumination driver 352 and data acquisition by receiver 320. However, illumination driver 352 and receiver 320 may not share the same clock as master controller 390. For this reason, precise estimation of time of flight can become computationally tedious when the pulse command signal 396 is directly used to trigger pulse generation and data acquisition.

In general, a LIDAR system 300 may include a number of different LIDAR measurement devices 330 each emitting illumination light from the LIDAR device into the surrounding environment and measuring return light reflected from objects in the surrounding environment.

In these embodiments, master controller 390 can communicate a pulse command signal 396 to each different LIDAR measurement device 330. In this manner, master controller 390 coordinates the timing of LIDAR measurements performed by any number of LIDAR measurement devices. In a further aspect, beam shaping optical elements 363 and beam scanning device 364 can be in the optical paths of the illumination light and return light associated with each of the LIDAR measurement devices. In this manner, beam scanning device 364 can direct each illumination signal and return signal of LIDAR system 300.

In the depicted embodiment, receiver 320 receives pulse command signal 396 and generates a pulse trigger signal 351 in response to the pulse command signal 396. Pulse trigger signal 351 is communicated to illumination driver 352 and directly triggers illumination driver 352 to electrically couple illumination source 360 to a power supply and generate illumination light 362. In addition, pulse trigger signal 351 can directly trigger data acquisition of amplified captured signal 381 and associated time of flight calculation. In this manner, pulse trigger signal 351 generated based on the internal clock of receiver 320 can be used to trigger both emission of illumination light and acquisition of return light. This approach ensures precise synchronization of illumination light emission and return light acquisition which enables precise time of flight calculations by time-to-digital conversion.

### Some Embodiments of Improved LiDAR Systems

Described herein are some embodiments of improved LiDAR systems with greater range and/or enhanced electro-optical efficiency.

In one aspect, the range and/or electro-optical efficiency of LiDAR systems may be improved by configuring such systems to reliably detect relatively weak optical signals. Biological systems (e.g., individual retinal cells) can perceive individual photons. Photodetectors (e.g., avalanche photodiodes (APDs), single-photon avalanche detectors (SPADs), etc.) can respond to individual photons under certain conditions. More generally, existing photodetectors may be capable of reliably detecting optical signals containing as few as 5 to 7 photons.

However, some conventional LiDAR systems may have difficulty reliably detecting optical signals containing fewer than approximately 250 photons. For example, the inventors have observed that a conventional LiDAR system (e.g., a system in which the receiver has an aperture diameter of 24 mm and the transmitter emits an optical pulse train with a wavelength of 905 nm, a laser firing rate (pulse frequency) of 82 kHz, a pulse duration of 4 ns, and an average optical power of 19 mW) may be able to detect a 10% target (i.e., a target having a diffuse reflectivity of 10%) at a maximum range of 140 meters. Under those conditions, the return signal received at the system's detector likely contains approximately 250 photons.

In some embodiments, improved LiDAR systems may be capable of reliably detecting optical return signals containing as few as 5 to 7 photons. Such systems may reliably detect a 10% target at a range of up to 630-980 meters (an improvement of up to 4.5× or even 7× over the range of a conventional LiDAR system) and/or reliably detect a 0.3% to 0.2% target at a range of 140 meters. Such improvements can be leveraged to reduce the cost and size of LiDAR systems while maintaining current performance levels, and/or to provide enhanced performance (range and/or sensitivity) in LiDAR systems at current form factors.

In some embodiments, improved LiDAR systems may use multi-mode, wavelength-locked laser diodes (e.g., provided by OSRAM SYLVANIA Inc.), in contrast to the multi-mode, high-power, non-wavelength-locked laser diodes that are used by many conventional LiDAR systems. As described in further detail below, in a well-designed LiDAR system using multi-mode, wavelength-locked laser diodes, the return signals processed by the receiver may exhibit significantly higher SNR than the return signals in conventional LiDAR systems.

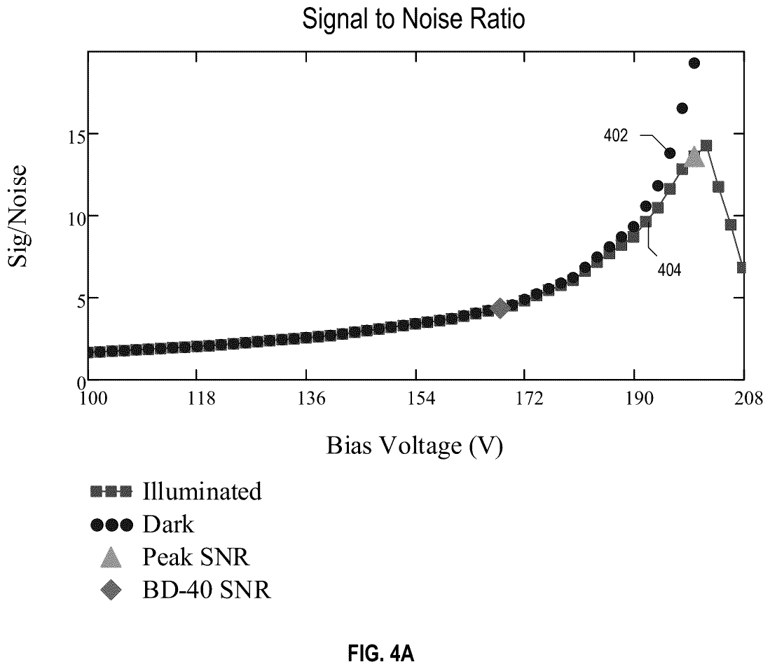

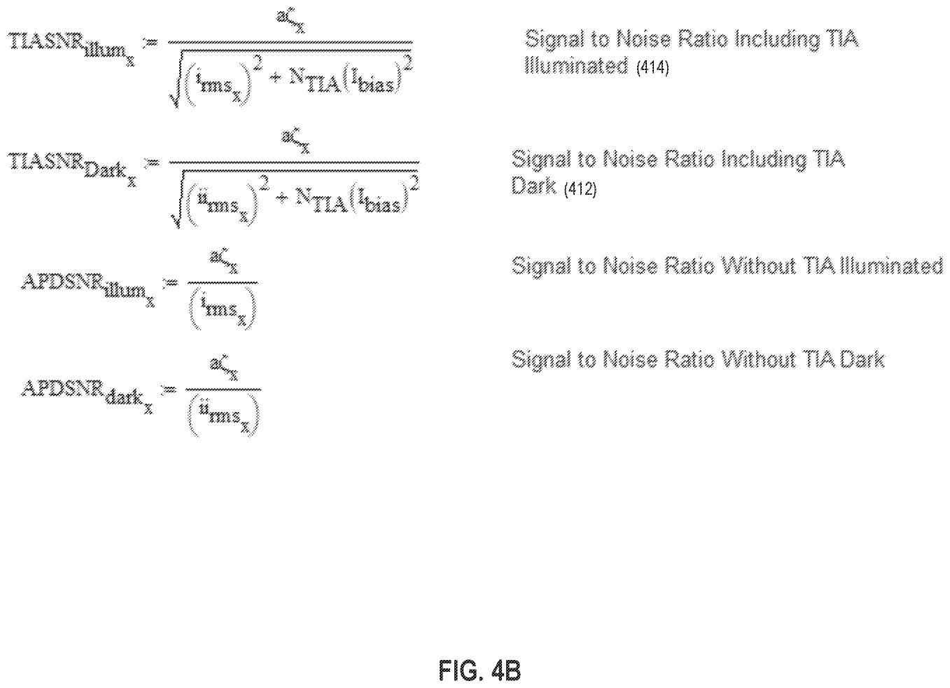

FIG. 4A shows two examples of scatter plots (402, 404) illustrating the SNR in return signals processed by a LiDAR receiver under various operating conditions. In the examples of FIG. 3, the LiDAR receiver uses an avalanche photodiode (APD) to detect the optical return signal and a transimpedance amplifier (TIA) to amplify the electrical signal generated by the APD. Thus, the ‘noise’ component of the SNR measurements illustrated in FIG. 3 includes the noise (e.g., average noise, for example, root mean square (RMS) noise) in the current generated by the APD and those noise introduced by the TIA.

Scatter plot 402 indicates the SNR observed in the amplified return signal in a dark ambient environment as the bias voltage of the APD varies from 100 V to approximately 200 V. Scatter plot 404 indicates the SNR observed in the amplified return signal in an illuminated (e.g., sunlit) ambient environment as the bias voltage of the APD varies from 100 V to the breakdown voltage of the APD (approximately 208 V in the example of FIG. 3). (Referring to FIG. 4, scatter plot 402 is generated using expression 412, and scatter plot 404 is generated using expression 414).

With reference to FIG. 3, the inventors have recognized and appreciated the following: (1) as the APD bias voltages approaches 100 V, the SNR reduces to nearly 1; (2) in dark or illuminated environments, the SNR of the amplified return signal peaks when the APD bias voltage is approximately 8 V less than the APD breakdown voltage (BD); (3) SNR can be increased by a factor of approximately 3× by biasing the APD at BD—8 V (see the triangle in FIG. 3) rather than BD—40 V (see the diamond in FIG. 3); (4) at APD bias vias voltages less than approximately BD—16 V, the SNR under dark conditions is very nearly the same as the SNR under illuminated conditions, indicating that filtering out sunlight when operating at such bias voltages does very little to improve SNR; and (5) in contrast, at APD bias voltages greater than approximately BD—16 V (and particularly at bias voltages greater than BD—8V), the SNR under dark conditions is considerably higher than the SNR under illuminated conditions, indicating that filtering out sunlight when operating at such bias voltages can substantially improve SNR.

In addition to recognizing that filtering sunlight is generally more beneficial when the APD bias voltage is within 8 to 16 V of the APD breakdown voltage, the inventors have also recognized and appreciated that using wavelength-locked multi-mode laser diodes facilitates the use of narrowband optical bandpass filters, which further enhances the benefits of the filtration. The transmission frequency of the beams emitted by non-wavelength-locked multi-mode laser diodes tends to drift considerably over the range of expected operating conditions for a LiDAR system (e.g., temperatures varying from −40° C. to 85° C.). Thus, if any optical bandpass filtering is performed on the return signals corresponding to such beams, a filter with a relatively wide passband (e.g., 100 nm or more) may be needed to accommodate the expected drift in the optical signal frequency. In contrast, the transmission frequency of the beams emitted by wavelength-locked multi-mode laser diodes may be much more stable over the range of expected operation conditions of a LiDAR system. For example, an optical bandpass filter with a passband much lower than 100 nm may be used. For example, an optical bandpass filter with a passband of approximately 20 nm (e.g., 10-30 nm, 15-25 nm, etc.) may be used in some embodiments of LiDAR systems equipped with the wavelength-locked laser diodes.

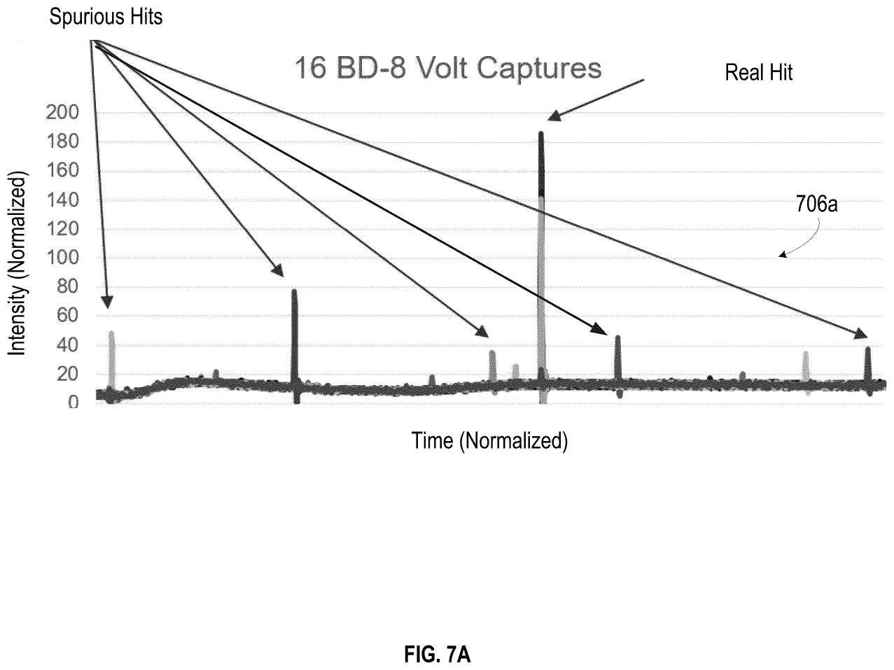

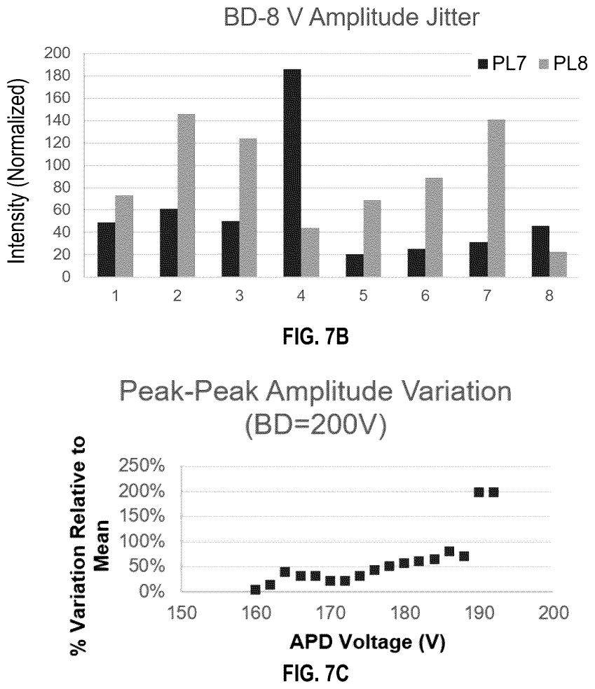

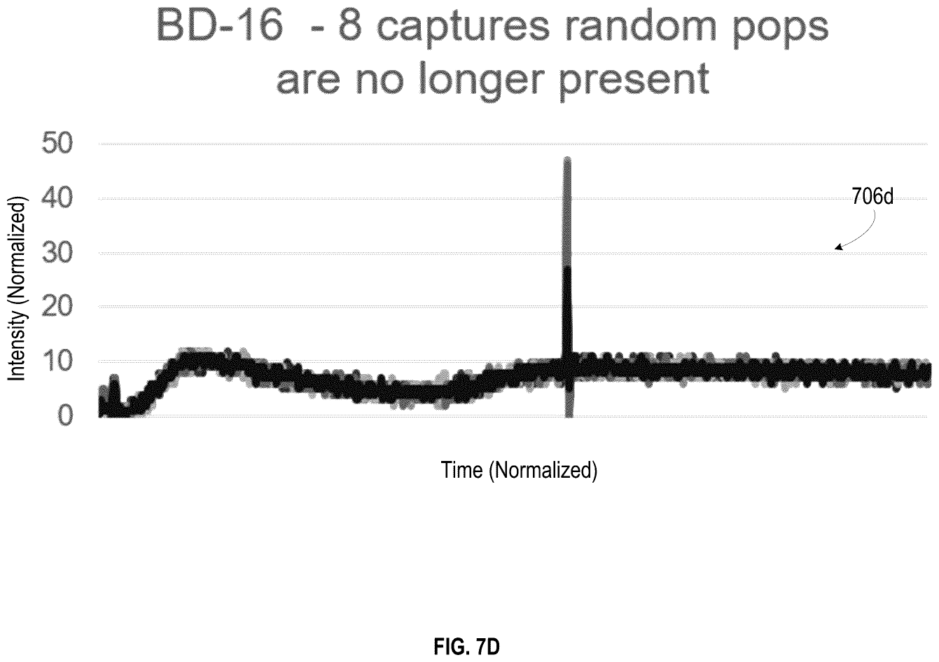

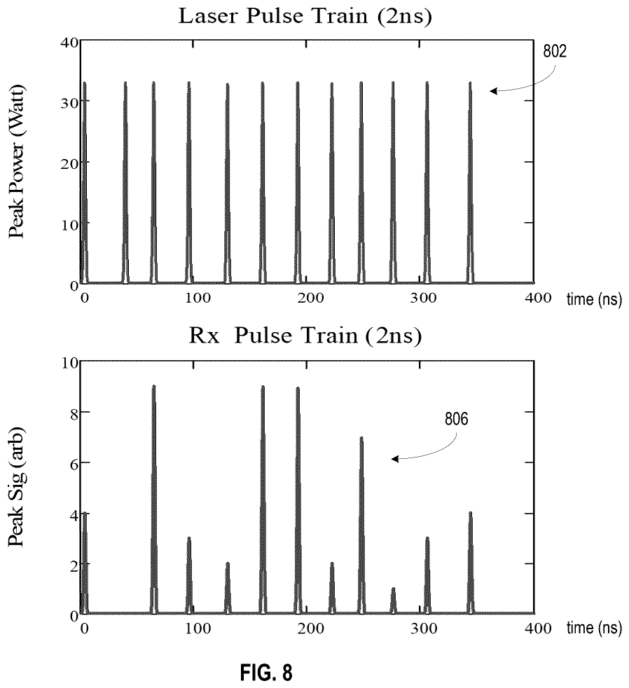

The scatter plots shown in FIG. 3 do not account for all sources of noise, e.g., Poisson noise and noise arising from spontaneous breakdown events (e.g., APD breakdowns resulting from the amplification of thermally generated electrons, cosmic rays, or other radiation sources). Under practical operating conditions, when the APD is biased at a high voltage (e.g., BD—16 V or higher), a large amount of peak-to-peak jitter (Poisson noise) and noise arising from relatively frequent spontaneous breakdown events may be observed in the signal generated by the detector. It can be difficult to distinguish real hits in a capture signal corresponding to actual peaks in the return signal (shown later in FIG. 7A) from spurious hits in a capture signal corresponding to the jitter arising from Poisson Noise (also shown later in FIG. 7A).

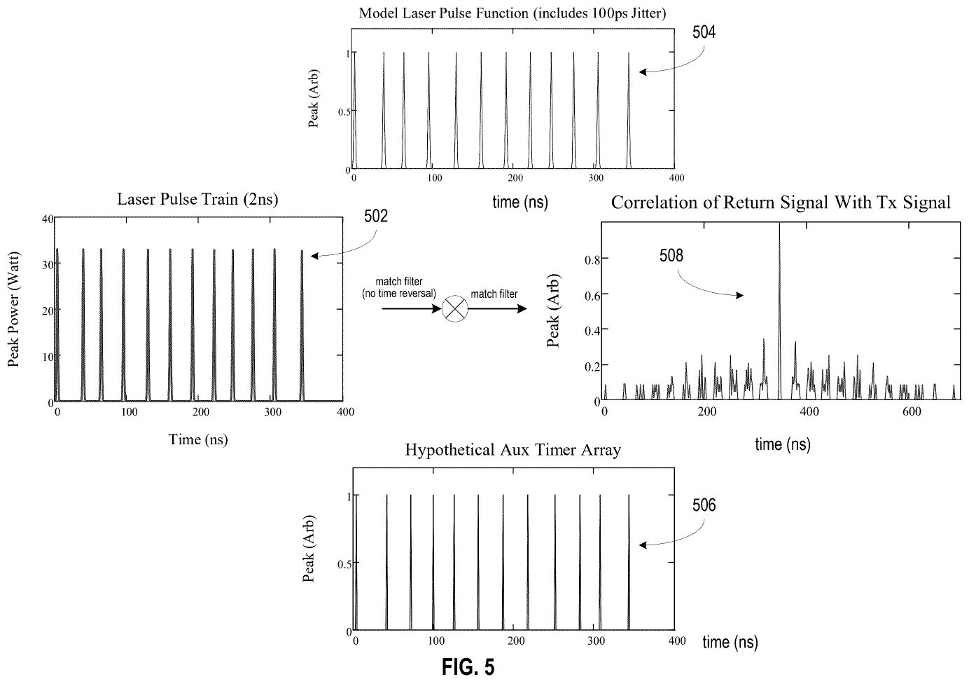

Referring to FIG. 3B, in some embodiments, a LiDAR receiver 320 may use digitization and digital signal processing techniques to enhance the receiver's ability to identify real hits even in the presence of significant jitter and/or spontaneous breakdown events. In some embodiments, the receiver may be implemented using an application specific integrated circuit (ASIC). As described above, the receiver 320 may include a controller 322, signal processing components 324, and timing circuitry 326. In some embodiments, the signal processing components 324 may include signal conditioning circuitry 341, N “trigger circuits” 342 (where N is any suitable positive integer), and a filter (e.g., match filter) 343. Each trigger circuit 342 may have a comparator and one or more registers. During the listening period corresponding to a transmitted ranging beam, an available trigger circuit may monitor the captured amplified signal 381 provided by the receiver's amplifier. If the comparator determines that the value of a portion (e.g., local peak) of the captured amplified signal 381 exceeds a pre-determined threshold, the trigger circuit 342 may sample the value of a timer (to obtain the time-of-flight corresponding to the local peak) and store the sampled time in the trigger register. The next available trigger circuit (or “lane”) may continue monitoring the return signal, and so on until the listening period ends or all the trigger circuits 342 have been triggered (“all the lanes are full”). The match filter 343 may then match the digitized waveform 323 captured by the trigger circuits (captured digital signal) to the signature of the transmitted signal using any suitable correlation detection technique (e.g., the techniques described below with reference to FIG. 5) to determine the actual time-of-flight associated with the optical return signal.

Any suitable number of trigger circuits may be used (e.g., 8-128, for example, 12, 24, 36, etc.). The threshold value of the comparators may be set to any suitable value. For example, the threshold value may be greater than the direct current (DC) offset and root mean square (RMS) noise floor of the captured amplified signal provided by the amplifier.

More generally, the threshold value selected for the trigger circuits may depend on the number of trigger circuits. As the threshold value decreases, the likelihood of filling each individual lane with a spurious hit increases, and the likelihood of filling all the lanes (with spurious hits or a mix of spurious hits and real hits) before all the peaks of the return signal have been detected also increases. However, as the number of trigger circuits increases, the likelihood of prematurely filling all the lanes decreases. Thus, as the number of trigger circuits increases, the minimum suitable threshold value may decrease. In any case, the number of trigger circuits and the threshold value may be set such that the likelihood of matching the digitized waveform to the signature of the transmitted signal is suitably high.

In some embodiments, the use of the digitization and digital signal processing techniques described herein may facilitate the use of APDs with higher gains than would normally be possible. In conventional LiDAR systems, APD gains in the range of 20-30× are common. In some embodiments, APD gains in the range of 80-100× may be used because the digitization and digital signal processing techniques described herein make the receiver more robust to the additional noise and spontaneous avalanche breakdowns associated with the higher APD gain.

In some embodiments, the digitization and digital signal processing techniques may interfere with the receiver's ability to reliably sense the reflectivity of the object that reflected the return signal. In particular, if the trigger circuits record only the time-of-flight of each hit and not a value indicative of the amplitude (e.g., intensity) of each hit, the receiver may not sense the reflectivity of the target. In such cases, if the LiDAR device is configured to report the reflectivity of targets, an arbitrary and/or fixed reflectivity value may be assigned. Alternatively, in some embodiments the trigger circuits may record not only the time-of-flight of each hit but also a value indicative of the amplitude of each hit. In such cases, the receiver may determine the reflectivity of the target based on the amplitudes of the real hits. The real hits may be distinguished from the spurious hits by matching the digitized waveform captured by the trigger circuits to the signature of the transmitted signal (e.g., using techniques described below with reference to FIG. 5).

FIG. 5 illustrates an embodiment of a technique for matching the digitized waveform captured by the trigger circuits (captured digital signal) to the signature of the transmitted signal. In the example of FIG. 5, examples of a laser pulse train 502, a laser pulse signature 504, a digitized return signal 506 (captured digital signal) captured by the trigger circuits, and a correlation waveform 508 are shown.

The laser pulse train 502 may be emitted by a transmitter of the LiDAR system. In this example, the laser pulse train 502 is an optical signal containing 12 pulses separated by intervals of 30 ns plus a random factor (e.g., between 1 and 10 ns), and each of the pulses has a width (duration) of approximately 2 ns. The pulse amplitude may be relatively low compared to pulse amplitude in LiDAR systems that do not use the waveform matching detection techniques described herein (e.g., 33% of the maximum amplitude supported by the laser). The laser pulse signature 504 may be an electrical signal that represents the laser pulse train 502. In some embodiments, the laser pulse signature 504 may be used by the LiDAR transmitter's driver circuit to drive the laser that emits the laser pulse train 502.

The digitized return signal 506 may be a digital waveform generated by the receiver during the listening period following the transmission of the laser pulse train 502, with pulses corresponding to the times when the receiver's trigger circuits detected hits. In the example, the digitized return signal 506 is an idealized waveform in which each pulse corresponds to a real hit and no pulses correspond to spurious hits.

The correlation waveform 508 may be the output generated by any suitable correlation circuit or process whereby the laser pulse signature 504 is correlated with the digitized return signal 506. For example, the correlation waveform 508 may be generated by applying a match filter (with no time reversal) to the laser pulse signature 504 and the digitized return signal 506. Other suitable correlation functions may be used. The position of the largest peak of the correlation waveform 508 on the x-axis may correspond to the time-of-flight of the return signal.

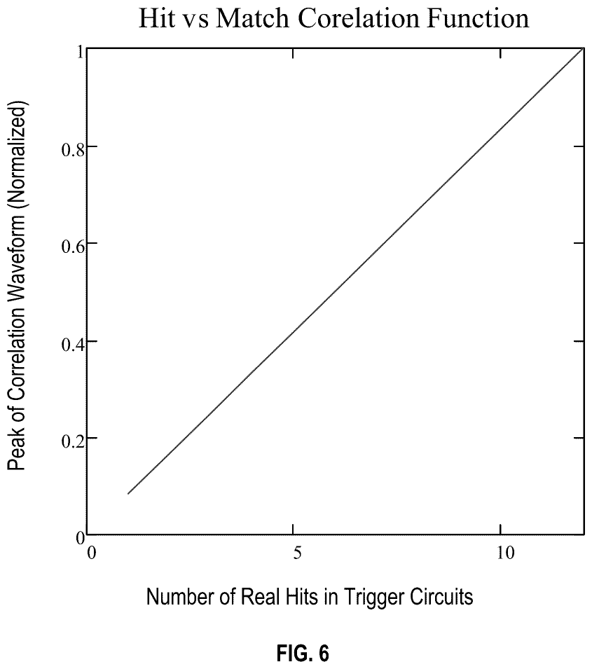

FIG. 6 shows a line graph illustrating the relationship between the number of real hits in the trigger circuits and the normalized peak value of the correlation waveform. In the example of FIG. 6, there are 12 pulses in the laser pulse train 502; thus, peak correlation occurs when the trigger circuits detect 12 return pulses (real hits). Empirically, the inventors have observed that matches between the digitized return signal 506 and the laser pulse signature 504 can be reliably detected when the minimum normalized peak correlation value required for a match is between 0.2 and 0.4 (e.g., when the number of real hits detected by the receiver is 4 or more).

FIG. 7A shows another example of a digitized return signal 706a. In the example of FIG. 7A, the x-axis is proportional to time. The digitized return signal 706a of FIG. 7A is captured using an APD with bias voltage of BD—8 V and trigger circuits having a threshold of approximately 40 units (on the scale of the output of the analog-to-digital converter (ADC)). In this example, the receiver detects 6 hits (5 spurious hits and 1 real hit).

FIG. 7B shows examples of the amplitude jitter observed at the output of the ADC when the bias voltage of the APD is set to BD—8 V for two different transmitter power levels, PL7 and PL8.

FIG. 7C shows an example of the peak-to-peak amplitude variation observed at the output of the ADC as a function of the APD bias voltage, where the breakdown voltage of the APD is 200 V.

Together, FIGS. 7A-7C indicate that the peak amplitude jitter is quite substantial when the APD bias voltage is set to BD—8V.

FIG. 7D shows another example of a digitized return signal 706d. In the example of FIG. 7D, the x-axis is proportional to time. The digitized return signal 706d of FIG. 7D is captured using an APD with bias voltage of BD—16 V and trigger circuits having a threshold of approximately 40 units (on the scale of the output of the analog-to-digital converter (ADC)). In this example, the receiver detects 1 hit (0 spurious hits and 1 real hit). The SNR of the return signals illustrated in FIGS. 7A and 7D is roughly the same, but the signal gain is higher in FIG. 7D because the APD gain in FIG. 7A is higher, suggesting that an APD bias voltage of BD—8 V is generally preferable.

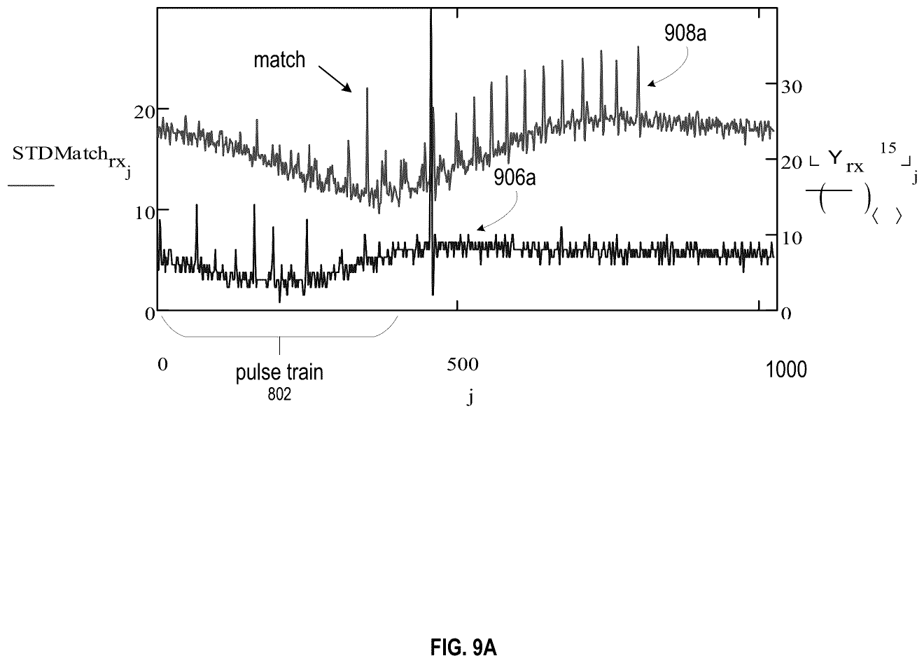

FIG. 8 shows additional examples of a laser pulse train 802 and a captured signal 806 corresponding to the reflected laser pulse train. In the example of FIG. 8, the captured signal 806 exhibits 10× amplitude variation due to the so-called excess noise factor in APDs. This excess noise factor is one of the key limitations of APD performance under certain operation conditions.

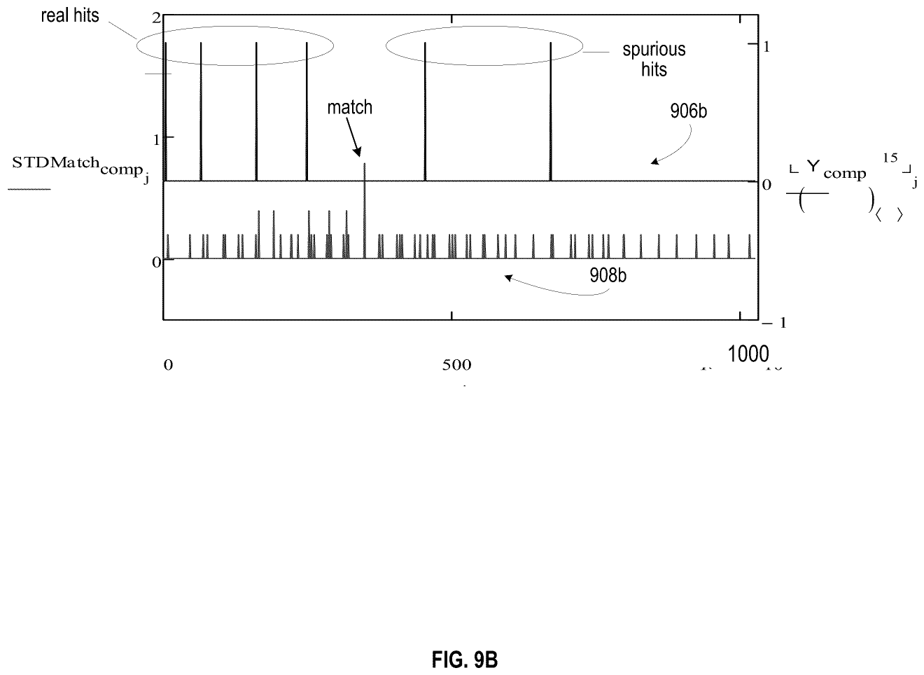

FIGS. 9A and 9B illustrate the results of simulations performed using the laser pulse train 802 and captured signal 806 of FIG. 8. In particular, FIG. 9A shows the results of a simulation performed using the laser pulse train 802 and the captured signal 806, with Poisson noise (jitter) introduced into the captured signal 806 to generate an analog return signal 906a (representing the simulated output of the detector). Also shown is an analog correlation waveform 908a, which is generated by applying a match filter to the analog return signal 906a and the laser pulse signature of the laser pulse train 802.

FIG. 9B shows the results of a simulation performed using the laser pulse train 802, the captured analog signal 906a, and an embodiment of the digitization and digital signal processing techniques described herein. In the example of FIG. 9B, the trigger circuits have a threshold of approximately 60% of the peak amplitude of the return signal; thus, the receiver detects only 4 of the 12 return pulses (real hits) and also detects 2 spurious pulses (spurious hits), as illustrated by the digitized return signal 906b. Also shown is the digital correlation waveform 908b, which is generated by applying a match filter to the digital return signal 906b and the laser pulse signature of the laser pulse train 802. As can be seen, with only 4 of the 12 return pulses detected and 2 spurious pulses detected, the receiver is able to correctly identify the point of maximum correlation between the laser pulse signature and the captured digital signal 906b, and therefore able to correctly determine the time-of-flight. Thus, the digital technique illustrated in FIG. 9B is significantly more computationally efficient than the analog technique illustrated in FIG. 9A (in which the entire waveform is processed, rather than processing a small number of samples).

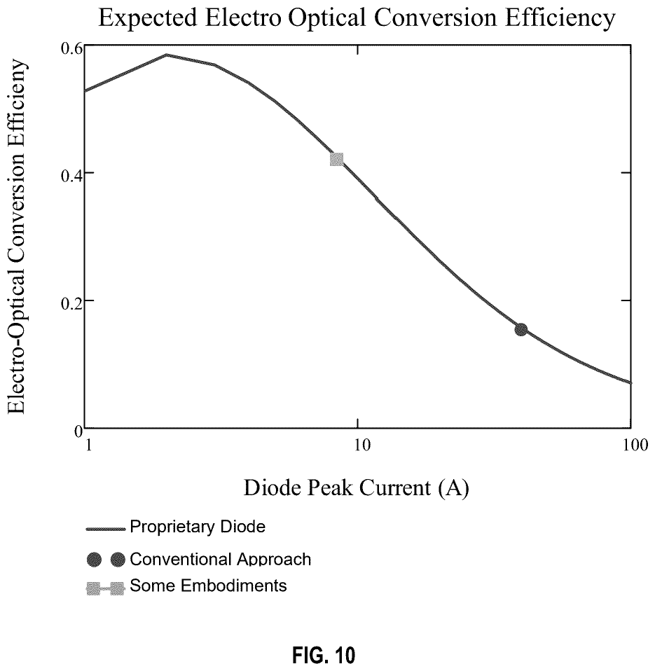

FIG. 10 illustrates the electro-optical conversion efficiency of a LiDAR transmitter as a function of the peak current through the laser diode (e.g., a wavelength-locked, multi-mode laser diode). In many conventional LiDAR systems, the electro-optical conversion efficiency is very low—as low as 6% or lower in some cases. By contrast, some embodiments (represented by the square in FIG. 10) may achieve an electro-optical conversion efficiency of roughly 0.43, with peak diode current of roughly 8.5 A and peak power of 30 W. Assuming the conventional LiDAR system S1 transmits a single 4 ns 100 W peak power laser pulse and a LiDAR system S2 according to an embodiment transmits a pulse train having 12 pulses of 2 ns and 30 W peak power, the heat loads of the two systems S1 and S2 may be approximately the same. More generally, FIG. 10 indicates that the range, SNR, and/or electro-optical efficiency of LiDAR systems can be improved by designing the receiver to detect an energy signature (pulse shape) rather than detecting peak power.

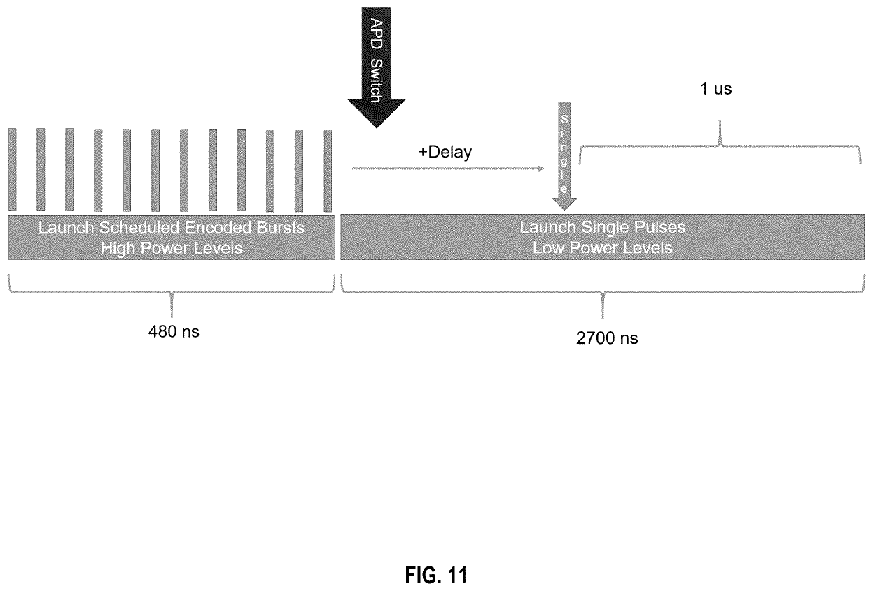

In some embodiments, a LiDAR channel may perform long-range detection and short-range detection within a single period of approximately 3 micro-seconds using the technique illustrated in FIG. 11. In the example of FIG. 11, a long-range (e.g., higher power) laser pulse train is transmitted at the beginning of the period corresponding to a laser position (LPOS). The pulse train may have a duration of approximately 480 ns.

After a brief delay for the retro-contamination window (e.g., “dazzle”) to pass, the channel's detector (e.g., APD) is activated and the listening period begins. During the listening period, one or more additional short-range (e.g., lower power) pulses may be transmitted. Long-range return signals and short-range return signals may be detected and distinguished during the listening period using the signal processing techniques described herein.

Relative to conventional LiDAR systems S1, a LiDAR system S2 according to some embodiments may exhibit an improvement in SNR of between 3× and 15×.

### System Embodiments

In embodiments, aspects of the techniques described herein may be directed to or implemented on information handling systems/computing systems. For purposes of this disclosure, a computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data for business, scientific, control, or other purposes. For example, a computing system may be a personal computer (e.g., laptop), tablet computer, phablet, personal digital assistant (PDA), smart phone, smart watch, smart package, server (e.g., blade server or rack server), a network storage device, or any other suitable device and may vary in size, shape, performance, functionality, and price. The computing system may include random access memory (RAM), one or more processing resources such as a central processing unit (CPU) or hardware or software control logic, ROM, and/or other types of memory. Additional components of the computing system may include one or more disk drives, one or more network ports for communicating with external devices as well as various input and output (I/O) devices, such as a keyboard, a mouse, touchscreen and/or a video display. The computing system may also include one or more buses operable to transmit communications between the various hardware components.

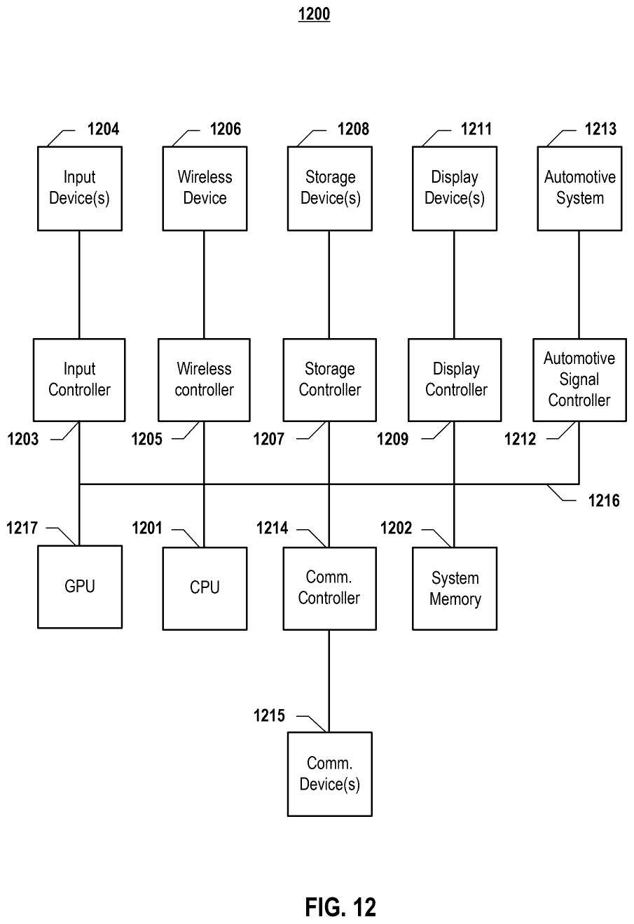

FIG. 12 depicts a simplified block diagram of a computing device/information handling system (or computing system) according to embodiments of the present disclosure. It will be understood that the functionalities shown for system 1200 may operate to support various embodiments of an information handling system—although it shall be understood that an information handling system may be differently configured and include different components.

As illustrated in FIG. 12, system 1200 includes one or more central processing units (CPU) 1201 that provides computing resources and controls the computer. CPU 1201 may be implemented with a microprocessor or the like, and may also include one or more graphics processing units (GPU) 1217 and/or a floating point coprocessor for mathematical computations. System 1200 may also include a system memory 1202, which may be in the form of random-access memory (RAM), read-only memory (ROM), or both.

A number of controllers and peripheral devices may also be provided, as shown in FIG. 12. An input controller 1203 represents an interface to various input device(s) 1204, such as a keyboard, mouse, or stylus. There may also be a scanner controller 1205, which communicates with a scanner 1206. System 1200 may also include a storage controller 1207 for interfacing with one or more storage devices 1208 each of which includes a storage medium such as magnetic tape or disk, or an optical medium that might be used to record programs of instructions for operating systems, utilities, and applications, which may include embodiments of programs that implement various aspects of the techniques described herein. Storage device(s) 1208 may also be used to store processed data or data to be processed in accordance with some embodiments. System 1200 may also include a display controller 1209 for providing an interface to a display device 1211, which may be a cathode ray tube (CRT), a thin film transistor (TFT) display, or other type of display. The computing system 1200 may also include an automotive signal controller 1212 for communicating with an automotive system 1213. A communications controller 1214 may interface with one or more communication devices 1215, which enables system 1200 to connect to remote devices through any of a variety of networks including the Internet, a cloud resource (e.g., an Ethernet cloud, an Fiber Channel over Ethernet (FCoE)/Data Center Bridging (DCB) cloud, etc.), a local area network (LAN), a wide area network (WAN), a storage area network (SAN) or through any suitable electromagnetic carrier signals including infrared signals.

In the illustrated system, all major system components may connect to a bus 1216, which may represent more than one physical bus. However, various system components may or may not be in physical proximity to one another. For example, input data and/or output data may be remotely transmitted from one physical location to another. In addition, programs that implement various aspects of some embodiments may be accessed from a remote location (e.g., a server) over a network. Such data and/or programs may be conveyed through any of a variety of machine-readable medium including, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Some embodiments may be encoded upon one or more non-transitory computer-readable media with instructions for one or more processors or processing units to cause steps to be performed. It shall be noted that the one or more non-transitory computer-readable media shall include volatile and non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that some embodiments may further relate to computer products with a non-transitory, tangible computer-readable medium that have computer code thereon for performing various computer-implemented operations. The media and computer code may be those specially designed and constructed for the purposes of the techniques described herein, or they may be of the kind known or available to those having skill in the relevant arts. Examples of tangible computer-readable media include, but are not limited to: magnetic media such as hard disks, floppy disks, and magnetic tape; optical media such as CD-ROMs and holographic devices; magneto-optical media; and hardware devices that are specially configured to store or to store and execute program code, such as application specific integrated circuits (ASICs), programmable logic devices (PLDs), flash memory devices, and ROM and RAM devices. Examples of computer code include machine code, such as produced by a compiler, and files containing higher level code that are executed by a computer using an interpreter. Some embodiments may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the techniques described herein. One skilled in the art will also recognize that a number of the elements described above may be physically and/or functionally separated into sub-modules or combined together.

In embodiments, aspects of the techniques described herein (e.g., timing the emission of the transmitted signal, processing received return signals, and so forth) may be directed to or implemented on information handling systems/computing systems. For purposes of this disclosure, a computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data for business, scientific, control, or other purposes. For example, a computing system may be a personal computer (e.g., laptop), tablet computer, phablet, personal digital assistant (PDA), smart phone, smart watch, smart package, server (e.g., blade server or rack server), a network storage device, or any other suitable device and may vary in size, shape, performance, functionality, and price.

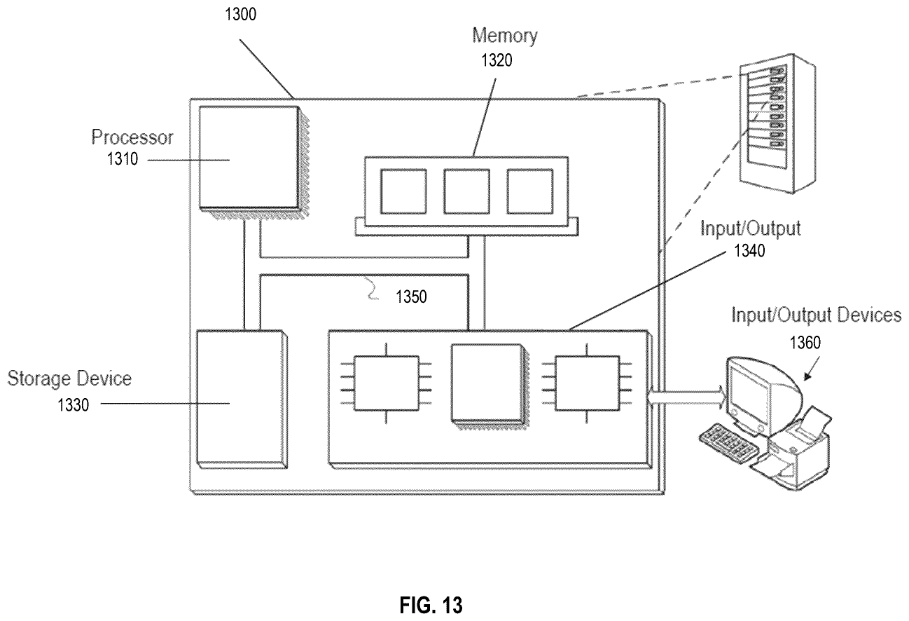

FIG. 13 is a block diagram of an example computer system 1300 that may be used in implementing the technology described in this document. General-purpose computers, network appliances, mobile devices, or other electronic systems may also include at least portions of the system 1300. The system 1300 includes a processor 1310, a memory 1320, a storage device 1330, and an input/output device 1340. Each of the components 1310, 1320, 1330, and 1340 may be interconnected, for example, using a system bus 1350. The processor 1310 is capable of processing instructions for execution within the system 1300. In some implementations, the processor 1310 is a single-threaded processor. In some implementations, the processor 1310 is a multi-threaded processor. The processor 1310 is capable of processing instructions stored in the memory 1320 or on the storage device 1330.

The memory 1320 stores information within the system 1300. In some implementations, the memory 1320 is a non-transitory computer-readable medium. In some implementations, the memory 1320 is a volatile memory unit. In some implementations, the memory 1320 is a non-volatile memory unit.

The storage device 1330 is capable of providing mass storage for the system 1300. In some implementations, the storage device 1330 is a non-transitory computer-readable medium. In various different implementations, the storage device 1330 may include, for example, a hard disk device, an optical disk device, a solid-date drive, a flash drive, or some other large capacity storage device. For example, the storage device may store long-term data (e.g., database data, file system data, etc.). The input/output device 1340 provides input/output operations for the system 1300. In some implementations, the input/output device 1340 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 1360. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 1330 may be implemented in a distributed way over a network, for example as a server farm or a set of widely distributed servers, or may be implemented in a single computing device.

Although an example processing system has been described in FIG. 13, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

### Terminology

Measurements, sizes, amounts, etc. may be presented herein in a range format. The description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as 10-20 inches should be considered to have specifically disclosed subranges such as 10-11 inches, 10-12 inches, 10-13 inches, 10-14 inches, 11-12 inches, 11-13 inches, etc.

Furthermore, connections between components or systems within the figures are not intended to be limited to direct connections. Rather, data or signals between these components may be modified, re-formatted, or otherwise changed by intermediary components. Also, additional or fewer connections may be used. The terms “coupled,” “connected,” or “communicatively coupled” shall be understood to include direct connections, indirect connections through one or more intermediary devices, and wireless connections.

Reference in the specification to “one embodiment,” “preferred embodiment,” “an embodiment,” “some embodiments,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated.

Furthermore, one skilled in the art shall recognize that: (1) certain steps may optionally be performed; (2) steps may not be limited to the specific order set forth herein; (3) certain steps may be performed in different orders; and (4) certain steps may be performed concurrently.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A LIDAR system, comprising:
a transmitter configured to transmit an optical signal having a signature;
a photodetector configured to detect a return signal and generate a captured signal representing the return signal, wherein the return signal comprises a portion of the optical signal reflected by a surface in an environment of the LIDAR system; and
a receiver configured to process the captured signal to determine a propagation time of the optical signal between the transmitter and the surface, the receiver including signal processing components and timing circuitry, wherein
the signal processing components are configured to digitize the captured signal and determine whether a signature of the digitized signal matches the signature of the optical signal, and
the timing circuitry is configured to determine the propagation time of the optical signal between the transmitter and the surface based on the digitized signal when the signature of the digitized signal is determined to match the signature of the optical signal.

2. The LIDAR system of claim 1, wherein the transmitter comprises a laser diode configured to emit the optical signal.

3. The LIDAR system of claim 2, wherein the laser diode is a multi-mode, wavelength-locked laser diode.

4. The LIDAR system of claim 1, wherein the photodetector is an avalanche photodiode (APD).

5. The LIDAR system of claim 4, wherein a bias voltage applied to the APD is approximately between 8 volts and 16 volts less than a breakdown voltage of the APD.

6. The LIDAR system of claim 5, wherein a gain of the APD is approximately between 80 and 100.

7. The LIDAR system of claim 1, further comprising an optical filter disposed in an optical path of the photodetector, wherein the photodetector is configured to detect the return signal after the return signal passes through the optical filter.

8. The LIDAR system of claim 7, wherein the optical filter is a bandpass filter with a passband width between approximately 15 ns and 25 ns.

9. The LIDAR system of claim 1, wherein the signal processing components include a plurality of trigger circuits each comprising a comparator and one or more registers.

10. The LIDAR system of claim 9, wherein each of the trigger circuits, when activated, is configured to sample a respective peak of the captured signal having an amplitude that exceeds a threshold value.

11. A method comprising:
transmitting, with a transmitter of a LIDAR system, an optical signal having a signature;
with a photodetector of the LIDAR system, detecting a return signal and generating a captured signal representing the return signal, wherein the return signal comprises a portion of the optical signal reflected by a surface in an environment of the LIDAR system; and
processing, with a receiver of the LIDAR system, the captured signal to determine a propagation time of the optical signal between the transmitter and the surface, wherein the processing includes:
digitizing the captured signal,
determining whether a signature of the digitized signal matches the signature of the optical signal, and
determining the propagation time of the optical signal between the transmitter and the surface based on the digitized signal when the signature of the digitized signal is determined to match the signature of the optical signal.

12. The method of claim 11, wherein transmitting the optical signal comprises a laser diode emitting the optical signal.

13. The method of claim 12, wherein the laser diode is a multi-mode, wavelength-locked laser diode.

14. The method of claim 11, wherein the photodetector is an avalanche photodiode (APD).

15. The method of claim 14, further comprising applying a bias voltage applied to the APD, wherein the bias voltage is approximately between 8 volts and 16 volts less than a breakdown voltage of the APD.

16. The method of claim 15, wherein a gain of the APD is approximately between 80 and 100.

17. The method of claim 11, further comprising filtering the return signal with an optical filter before the return signal detected by the photodetector.

18. The method of claim 17, wherein the optical filter is a bandpass filter with a passband width between approximately 15 ns and 25 ns.

19. The method of claim 11, wherein digitizing the captured signal comprises sampling a plurality of peaks of the captured signal having respective amplitudes in excess of a threshold value.
